(19) United States
(12) Patent Application Publication
(10) Pub. No.: US 2023/0096446 A1
(43) Pub. Date: Mar. 30, 2023

(54) TERMINAL INSERTION DEVICE

(71) Applicant: YAZAKI CORPORATION, Tokyo (JP)

(72) Inventors: Hajime NAGANO, Makinohara-shi (JP); Kazuhiko TAKADA, Makinohara-shi (JP); Katsuya YAMAZAKI, Makinohara-shi (JP)

(73) Assignee: YAZAKI CORPORATION, Tokyo (JP)

(21) Appl. No.: 17/948,815

(22) Filed: Sep. 20, 2022

(30) Foreign Application Priority Data
Sep. 27, 2021 (JP) 2021-157111

(51) Int. Cl. H01R 43/20; G01B 11/00; H01R 43/26

(52) U.S. Cl. CPC H01R 43/20; G01B 11/002; H01R 43/26; H01R 43/16

(57) ABSTRACT

A terminal insertion device includes a chuck gripping a terminal, a housing holder holding a housing, an imaging unit to capture an image of the housing, a driving mechanism and a control unit. The control unit measures a distance from a reference point of a field of view of the imaging unit to a positioning target portion in the field of view based on an image obtained, measures a movement amount of a gripping point of the chuck when a measurement pin gripped by the chuck is aligned with the positioning target portion, calculates a reference distance between the gripping point and the reference point based on the distance and the movement amount, captures an image to identify a position of a cavity of the housing, drives the driving mechanism based on the calculated reference distance, and aligns and inserts the terminal into the identified cavity.

### CROSS-REFERENCE TO RELATED APPLICATION

The present application claims priority to Japanese Patent Application No. 2021-157111 filed on Sep. 27, 2021, the entire content of which is incorporated herein by reference.

### TECHNICAL FIELD

The presently disclosed subject matter relates to a terminal insertion device.

### BACKGROUND

In the related art, a device is disclosed in which an image processing unit executes image processing on a video of a connector housing captured by an imaging unit provided at a position adjacent to a gripping mechanism, and a teaching control unit automatically adjusts a relative positional relationship between a position of a terminal grasped by the terminal insertion device and a cavity position of the connector housing based on a result of the image processing (for example, see JP2016-58320A).

Since the above-described device is intended to execute teaching based on the image of the housing captured by a camera, it is difficult to perform positioning taking into account of an influence of an individual difference of the housing and a tolerance of a housing holding portion.

### SUMMARY

Illustrative aspects of the presently disclosed subject matter provide a terminal insertion device capable of smoothly inserting a terminal into a cavity of a housing regardless of a shape of the housing.

The above-described object of the presently disclosed, subject matter is achieved by the following configuration.

According to an illustrative aspect of the presently disclosed subject matter, a terminal insertion device includes a chuck configured to grip a terminal, a housing holder holding a housing, an imaging unit fixed to the chuck and configured to capture an image of the housing, a driving mechanism configured to move the chuck and a control unit configured to control the driving mechanism to insert the terminal held by the chuck into a cavity of the housing. The control unit is configured to measure a distance from a reference point of a field of view of the imaging unit to a positioning target portion in the field of view based on an image obtained by the imaging unit imaging the positioning target portion, measure a movement amount of a gripping point of the chuck when a measurement pin gripped by the chuck is aligned with the positioning target portion by driving the driving mechanism, calculate a reference distance between the gripping point of the chuck and the reference point of the field of view of the imaging unit based on the distance and the movement amount, capture an image of the housing by the imaging unit to identify a position of the cavity, drive the driving mechanism based on the calculated reference distance, and align and insert the terminal held by the chuck into the identified cavity.

Other aspects and advantages of the presently disclosed subject matter will be apparent from the following description, the drawings and the claims.

### BRIEF DESCRIPTION OF DRAWINGS

FIG. 1 is a schematic perspective view of a terminal insertion device according to the present embodiment;

FIG. 2 is a view taken in a direction of an arrow A in FIG. 1;

FIG. 3 is a schematic view showing a positional relationship between a chuck and a field of view of a camera;

FIG. 4 is a schematic view showing a jig and the field of view of the camera;

FIG. 5 is a schematic view showing a state in which the chuck is aligned with a hole of the jig;

FIG. 6 is a schematic view showing a relationship between a reference point of the field of view and a gripping point of the chuck;

FIG. 7 is a schematic view of a state in which the field of view is aligned with a cavity of the housing for master registration; and

FIG. 8 is a schematic view showing the relationship between the cavity of the housing and the gripping point of the chuck.

### DESCRIPTION OF EMBODIMENTS

A specific embodiment of the presently disclosed subject matter will be described below with reference to the drawings.

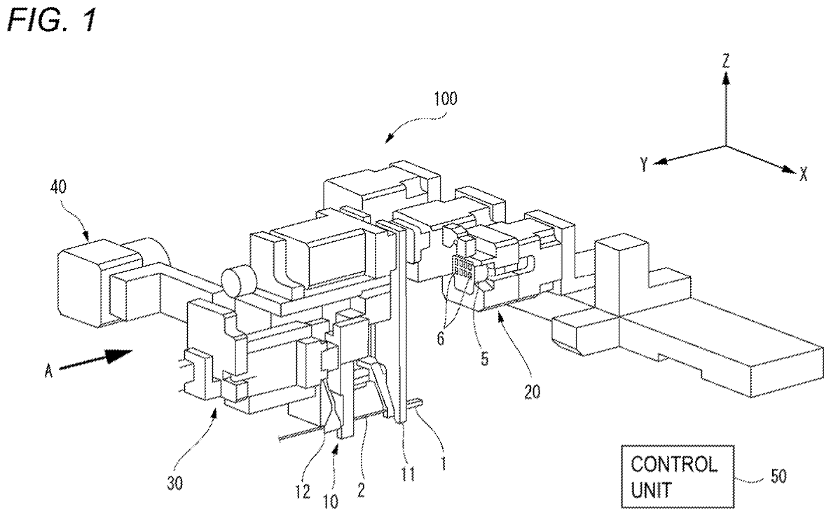

FIG. 1 is a schematic perspective view of a terminal insertion device according to the present embodiment.

As shown in FIG. 1, a terminal insertion device 100 according to the present embodiment includes a chuck 10 that grips, a terminal 1, and a housing holder 20 that holds a housing 5. The terminal insertion device 100 is a device that inserts the terminal 1 gripped by the chuck 10 into a cavity 6 of the housing 5 held by the housing holder 20. The terminal 1 is formed of a conductive metal material and is connected to an end portion of an electric wire 2. The terminal 1 is inserted into and accommodated in the cavity 6 of the housing 5.

The chuck 10 includes a terminal chuck portion 11 and an electric wire chuck portion 12. In the chuck 10, the terminal chuck portion 11 grips the terminal 1, and the electric wire chuck portion 12 grips the electric wire 2. The chuck 10 rotatably drives the terminal 1 about an axial center of the terminal 1. The housing holder 20 holds the housing 5. The housing 5 is molded from a synthetic resin and has a plurality of cavities 6 for accommodating the terminal 1. The housing holder 20 holds the housing 5 such that an opening on a rear portion side of the plurality of cavities 6 faces a chuck 10 side.

The terminal insertion device 100 further includes a driving mechanism 30, a camera (an imaging unit) 40, and a control unit 50.

The driving mechanism 30 moves the chuck 10 in a horizontal plane (an X direction and a Y direction) and moves the chuck 10 in an upper-lower direction (a Z direction). The driving mechanism 30 inserts, by moving the chuck 10, the terminal 1 gripped by the chuck 10 into the cavity 6 of the housing 5 held by the housing holder 20,

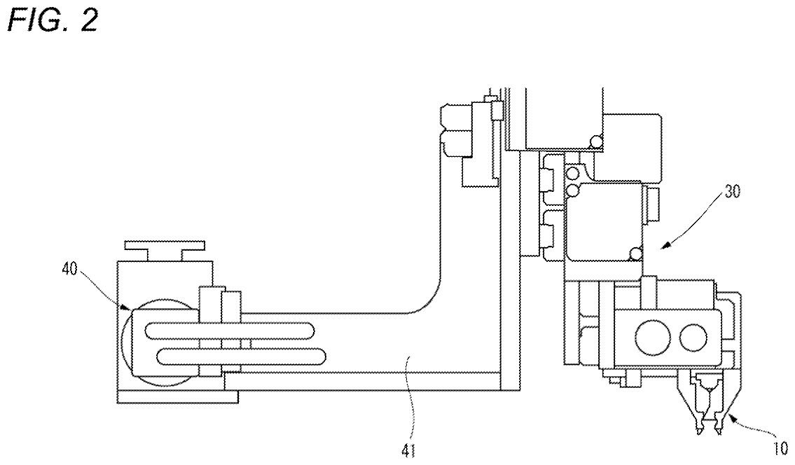

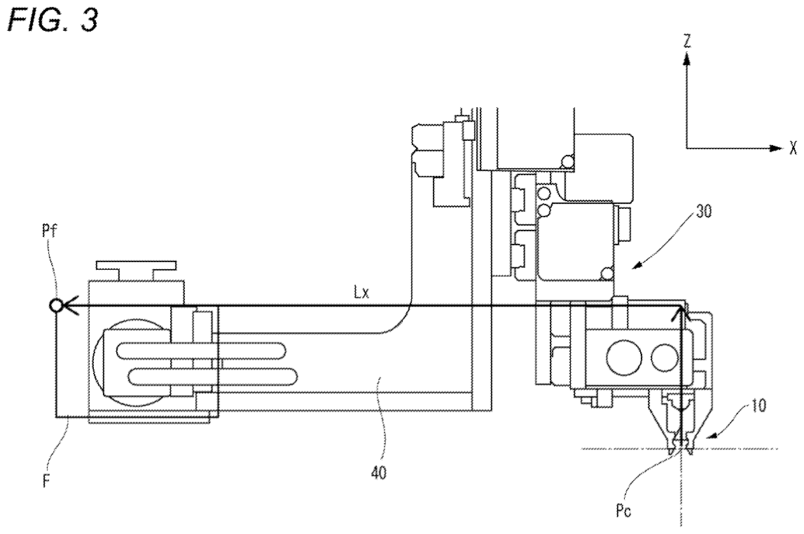

FIG. 2 is a view taken in a direction of an arrow A in FIG. 1. FIG. 3 is a schematic view showing a positional relationship between a chuck and a field of view of a camera.

As shown in FIG. 2, the camera 40 is fixed to the chuck 10 via a frame 41, and is moved together with the chuck 10 by the driving mechanism 30. The camera 40 is supported on a side of the chuck 10, and an imaging direction of the camera 40 is directed toward the housing holder 20 holding the housing 5. The camera 40 captures an image of the housing 5 held by the housing holder 20 in a state in which the camera 40 is provided at a position facing the housing holder 20 by the driving mechanism 30. As the camera 40, for example, a CCD camera can be used.

As shown in FIG. 3, the camera 40 has a field of view F, and one point (in this example, one corner) in a left-right direction the X direction) and the upper-lower direction (the Z direction) is set as a reference point Pt The chuck 10 has a gripping point Pc in the left-right direction (the X direction) and the upper-lower direction (the Z direction), and grips the terminal 1 at the gripping point Pc.

The control unit 50 is connected to the chuck 10, the housing holder 20, and the driving mechanism 30, and controls driving units of the chuck 10, the housing holder 20, and the driving mechanism 30. Further, the camera 40 is connected to the control unit 50, and image data is transmitted from the camera 40.

The control unit 50 obtains a position of the cavity 6 of the housing 5 held by the housing holder 20 based on the image data from the camera 40. Then, the driving mechanism 30 is driven to move and position the terminal 1 held by the chuck 10 with respect to the cavity 6 in the left-right direction (the X direction) and the upper-lower direction (the Z direction), and to move the terminal 1 in the direction (the Y direction) toward the housing 5. Accordingly, the terminal 1 is inserted into the cavity 6.

Next, various types of processing and operations performed by the control unit 50 of the terminal insertion device 100 will be described.

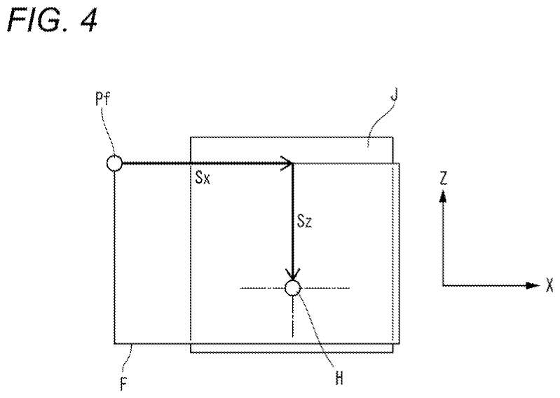

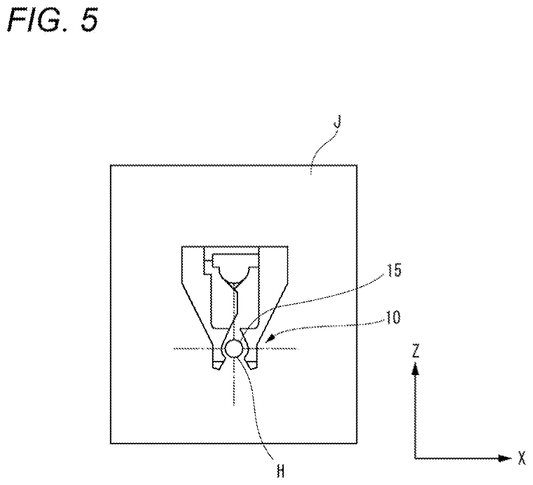

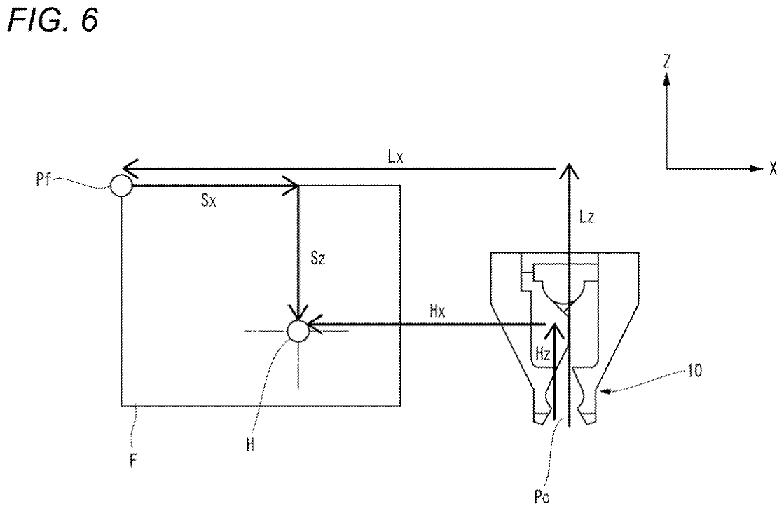

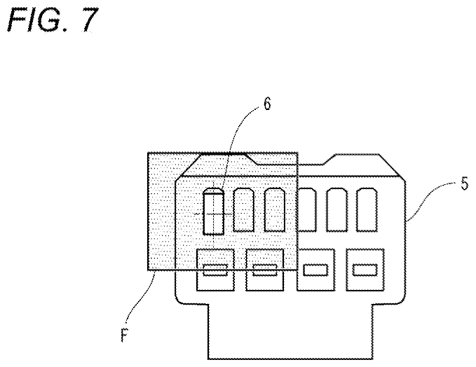

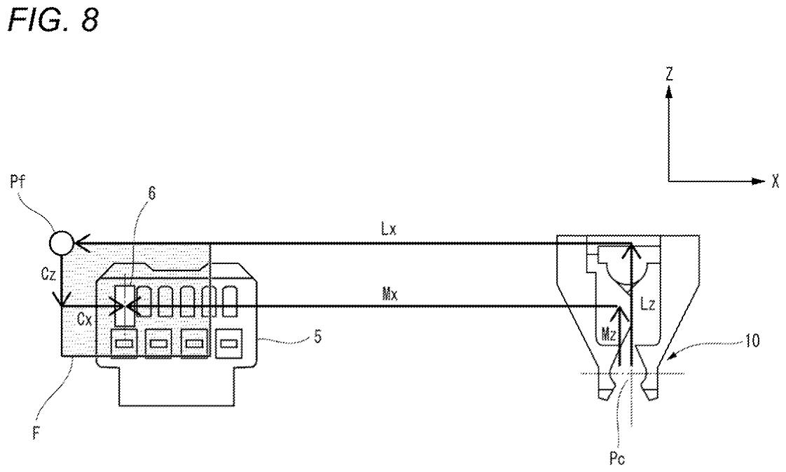

FIG. 4 is a schematic view showing a jig and the field of view of the camera. FIG. 5 is a schematic view showing a state in which the chuck is aligned with a hole of the jig. FIG. 6 is a schematic view showing a relationship between a reference point of the field of view and a gripping point of the chuck. FIG. 7 is a schematic view of a state in which the field of view is aligned with a cavity of the housing for master registration. FIG. 8 is a schematic view showing the relationship between the cavity of the housing and the gripping point of the chuck.

Positioning setting processing is executed to determine reference distances Lx, Lz between the gripping point Pc of the chuck 10 and the reference point Pf of the field of view F of the camera 40 in the terminal insertion device 100 (see FIG. 3).

First, as shown in FIG. 4, a plate-shaped jig J having a hole H serving as a positioning target portion is attached to the housing holder 20. In this state, the driving mechanism 30 is driven, the camera 40 is provided at the position facing the housing holder 20 such that the hole H of the jig j is formed in the field of view F, and an image of the hole H is captured by the camera 40. Next, based on the captured image, distances Sx, Sz in the left-right direction (the X direction) and the upper-lower direction (the Z direction) from the reference point Pf to the hole H in the field of view F are measured.

Next, as shown in FIG. 5, the chuck 10 is caused to grip the measurement pin 15 and the driving mechanism 30 is driven, so that the measurement pin 15 is provided at a position where the measurement pin 15 is inserted into the hole H of the jig J. Accordingly, movement amounts Hx, Hz of the gripping point Pc of the chuck 10 in the left-right direction (the X direction) and the upper-lower direction (the Z direction) are measured.

The movement amounts Hx, Hz are obtained according to the following expressions (1) and (2) based on coordinates (hx1, hz1) before the movement of the chuck 10 and coordinates (hx2, hz2) after the movement of the chuck 10. The coordinates (hx1, hz1) before the movement and the coordinates (hx2, hz2) after the movement are obtained based on origin coordinates of the driving mechanism 30.

Hx=hx2−hx1 (1), and

Hz=hz2−hz1 (2).

Thereafter, as shown in FIG. 6, the reference distances Lx, Lz between the gripping point Pc of the chuck 10 and the reference point Pf of the field of view F of the camera 40 in the left-right direction (the X direction) and the upper-lower direction (the Z direction) are obtained based on the obtained distances Sx, Sr and the movement amounts Hx, Hz according to the following expressions (3) and (4).

Lx=Hz+Sx (3), and

Lz=Hz+Sz (4).

As shown in FIG. 7, the control unit 50 aligns the field of view F of the camera 40 with the housing 5 for master registration held by the housing holder 20, and causes the camera 40 to capture an image of a part including the cavity 6. Then, based on the image captured by the camera 40, the specific cavity 6 in the field of view F is registered.

The control unit 50 positions and inserts the terminal 1 into the cavity 6 of the housing 5 held by the housing holder 20 based on the reference distances Lx, Lz obtained by the positioning setting processing and registration information of the cavity 6 registered by master registration processing.

Specifically, as shown in FIG. 8, the control unit 50 aligns the field of view F of the camera 40 with the housing 5 held by the housing holder 20, and causes the camera 40 to capture an image of the part including the cavity 6. Then, based on the image captured by the camera 40 and the registered information of the master registered cavity 6, the cavity 6 is identified into which the terminal 1 in the captured image is to be inserted. Next, the control unit 50 obtains distances Cx, Cz from the reference point Pf in the field of view F to the identified cavity 6 in the left-right direction (the X direction) and the upper-lower direction (the Z direction).

Next, the control unit 50 obtains moving distances Mx, Mz during insertion according to the following expressions (5) and (6) based on the obtained distances Cx, Cz and the reference distances Lx, Lz obtained by the positioning setting processing.

Mx=Lx−Cz (5), and

Mz=Lz−Cz (6).

Then, the control unit 50 drives the driving mechanism 30, moves the chuck 10 gripping the terminal 1 by the obtained moving distances Mx, Mz, positions the terminal 1 gripped by the chuck. 10 in the cavity 6 of the housing 5, and moves the terminal f in the direction (the Y direction) toward the housing 5. Accordingly, the terminal 1 is inserted into the cavity 6. At this time, when the terminal 1 is displaced with respect to the gripping, point Pc due to bending or the like, the control unit 50 adjusts the position of the terminal 1 with respect to the cavity 6 based on the displacement with respect to the gripping point Pc. When the terminal 1 is inclined with respect to the cavity 6, the driving unit of the chuck 10 may be controlled to perform adjustment such that the terminal 1 is rotated and an attitude of the terminal 1 is aligned with the cavity 6.

As described above, according to the terminal insertion device 100 in the present embodiment, since the positioning is performed based on the reference distances Lx, Lz between the gripping point Pc of the chuck 10 calculated using the hole H of the jig J which is the positioning target portion and the reference point Pf of the field of view F, the terminal 1 can be smoothly inserted into the specific cavity 6 of the housing 5 regardless of a shape of the housing 5. Further, since the jig J having the hole H as the positioning target portion used when positioning is performed can be freely positioned as long as the jig J is in the field of view F of the camera 40, a degree of freedom of the positioning can be increased.

Since the hole H of the jig J provided in the housing holder 20 is set as the positioning target portion, an error in positioning the terminal 1 with respect to the cavity 6 of the housing 5 can be further reduced, and an operation range of the device required for positioning and terminal insertion can be narrowed.

In the above-described embodiment, in the positioning setting processing, the jig J having the hole H which is the positioning target portion is held in the housing holder 20. Alternatively, for example, a reference portion such as a hole formed in advance in the housing holder 20 may be used as the positioning target portion.

While the presently disclosed subject matter has been described with reference to certain exemplary embodiments thereof, the scope of the presently disclosed subject matter is not limited to the exemplary embodiments described above, and it will be understood by those skilled in the an that various changes and modifications may be made therein without departing from the scope of the presently disclosed subject matter as defined by the appended claims.

According to an aspect of the embodiments described above, a to insertion device includes a chuck (10) configured to grip a terminal (1), a housing holder (20) holding a housing (5), an imaging unit (for example, a camera 40) fixed to the chuck (10) and configured to capture an image of the housing (5), a driving mechanism (30) configured to move the chuck (10) and a control unit (50) configured to control the driving mechanism (30) to insert the terminal (1) held by the chuck (10) into a cavity (6) of the housing (5). The control unit (50) is configured to measure a distance (Sx, Sz) from a reference point (Pf) of a field of view (F) of the imaging unit (the camera 40) to a positioning target portion (for example, a hole H) in the field of view (F) based on an image obtained by the imaging unit (the camera 40) imaging the positioning target portion (the hole H), measure a movement amount (Hx, Hz) of a gripping point (Pc) of the chuck (10) when a measurement pin (15) gripped by the chuck (10) is aligned with the positioning target portion (the hole H) by driving the driving mechanism (30), calculate a reference distance (Lx, Lz) between the gripping point (Pc) of the chuck (10) and the reference point (Pf) of the field of view (F) of the imaging unit (the camera 40) based on the distance (Sx, Sz) and the movement amount (Hx, Hz), capture an image of the housing (5) by the imaging unit (the camera 40) to identify a position of the cavity (6), drive the driving mechanism (30) based on the calculated reference distance (Lx, Lz), and align and insert the terminal (1) held by the chuck (10) into the identified cavity (6).

According to the terminal insertion device having an above-described configuration, since the positioning is performed based on the reference distances between the gripping point of the chuck calculated using the positioning target portion and the reference point of the field of view, the terminal can be smoothly inserted into the specific cavity of the housing regardless of a shape of the housing. Further, since the positioning target portion used when positioning is performed can be freely provided as long as the positioning target portion is in the field of view of the imaging unit, a degree of freedom of the positioning can be increased.

The positioning target portion may be a hole (H) of a jig (J) provided in the housing holder (20).

With this configuration, since the hole which is the positioning, target portion is formed at a position close to the cavity of the housing, an error in positioning the terminal in the cavity of the housing can be further reduced, and an operation range of the device required for positioning and terminal insertion can be narrowed.

A position of the terminal (1) with respect to the cavity (6) may be adjusted based on displacement of the terminal (1) held by the chuck (10) with respect to the gripping point (Pc) to insert the terminal (1) into the cavity (6).

With this configuration, the terminal can be more smoothly inserted by accurate aligning the terminal with the cavity in consideration of the displacement of the terminal with respect to the gripping point due to bending or the like.

What is claimed is:

1. A terminal insertion device comprising:
a chuck configured to grip a terminal;
a housing holder holding a housing;
an imaging unit fixed to the chuck and configured to capture an image of the housing;
a driving mechanism configured to move the chuck; and
a control unit configured to control the driving mechanism to insert the terminal held by the chuck into a cavity of the housing,
wherein the control unit is configured to:
measure a distance from a reference point of a field of view of the imaging unit to a positioning target portion in the field of view based on an image obtained by the imaging unit imaging the positioning target portion;
measure a movement amount of a gripping point of the chuck when a measurement pin gripped by the chuck is aligned with the positioning target portion by driving the driving mechanism;
calculate a reference distance between the gripping point of the chuck and the reference point of the field of view of the imaging unit based on the distance and the movement amount;
capture an image of the housing by the imaging unit to identify a position of the cavity; drive the driving mechanism based on the calculated reference distance; and align and insert the terminal held by the chuck into the identified cavity.

2. The terminal insertion device according to claim 1, wherein the positioning target portion is a hole of a jig provided in the housing holder.

3. The terminal insertion device according to claim 1,
wherein a position of the terminal with respect to the cavity is adjusted based on displacement of the terminal held by the chuck with respect to the gripping point to insert the terminal into the cavity.
